(19) United States
(12) Patent Application Publication
(10) Pub. No.: US 2013/0321432 A1
(43) Pub. Date: Dec. 5, 2013

(54) LIGHT GUIDE WITH EMBEDDED FRESNEL REFLECTORS

(71) Applicant: David William Burns, San Jose, CA (US)

(72) Inventor: David William Burns, San Jose, CA (US)

(73) Assignee: QUALCOMM MEMES Technologies, Inc., San Diego, CA (US)

(21) Appl. No.: 13/490,953

(22) Filed: Jun. 7, 2012

Related U.S. Application Data
(60) Provisional application No. 61/654,623, filed on Jun. 1, 2012.

(51) Int. Cl. G06T 1/00; F21V 7/04; B23P 17/00; F21V 8/00

(52) U.S. Cl. 345/501; 362/615; 362/623; 362/613; 29/530

(57) ABSTRACT

This disclosure provides systems, methods and apparatus for an optical system including a light guide and a plurality of angled slots. The angled slots are defined by undercuts in the light guide and are filled with a filler material having a refractive index that is mismatched with the refractive index of the light guide material by about 0.3 or less. The angled slots are configured to eject light out of the light guide principally by Fresnel reflections. Layers formed of the filler material can be disposed along each of the bottom and top major surfaces of the light guide. In some implementations, the light guide is attached to a light source. The light source emits light that is injected into the light guide and the angled slots redirect the light out of the light guide toward a desired target. In some implementations, the target is a display.

### CROSS-REFERENCE TO RELATED APPLICATIONS

This disclosure claims priority to U.S. Provisional Patent Application No. 61/654623, filed Jun. 1, 2012, entitled “LIGHT GUIDE WITH EMBEDDED FRESNEL REFLECTORS,” and assigned to the assignee hereof. The disclosure of the prior application is considered part of, and is incorporated by reference in, this disclosure.

### TECHNICAL FIELD

This disclosure relates generally to optical systems for guiding light and, more particularly, to light guides utilizing Fresnel reflector structures to redirect light.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as reflective displays using display elements formed by interferometric modulators. The perceived brightness of these displays depends upon the amount of light that is reflected towards a viewer. In low ambient light conditions, light from an illumination device with an artificial light source can be used to illuminate the reflective display elements, which can then reflect the light towards a viewer to generate an image. To meet market demands and design criteria for display devices, including reflective and transmissive displays, new illumination devices and methods for forming them are being developed. More generally, optical systems with light guides are being developed to provide improved light guiding and light redirecting properties.

### SUMMARY

The systems, methods and devices of the disclosure each have several innovative aspects, no single one of which is solely responsible for the desirable attributes disclosed herein.

One innovative aspect of the subject matter described in this disclosure can be implemented in an optical system. The optical system can include a light guide formed of a material with a refractive index. The light guide can include a first major surface, a second major surface opposite the first major surface, and a plurality of angled slots defined by undercuts extending from the first major surface toward the second major surface and partially through the light guide. The plurality of angled slots can be filled with a filler material having a refractive index. The refractive indices of the filler material and the light guide material can be mismatched by about 0.3 or less. In some implementations, the refractive indices of the filler material and the light guide material can be mismatched by about 0.1 or less, or 0.05 or less.

Another innovative aspect of the subject matter described in this disclosure can be implemented in an optical system. The optical system includes a light guide formed of a material with a refractive index. The light guide includes a first major surface, a second major surface opposite the first major surface, and means for ejecting light that is propagating through the light guide. The light propagates through the light guide by total internal reflection and the means for ejecting light can eject the light principally by use of Fresnel reflections, so that the light exits out of the light guide through the first major surface.

Yet another innovative aspect of the subject matter described in this disclosure can be implemented in a method of manufacturing an optical system. The method includes providing a light guide formed of a material with a refractive index and forming a plurality of angled slots defined by undercuts extending from the first major surface partially through the light guide. The light guide includes a first major surface and a second major surface opposite the first major surface. The plurality of angled slots can be filled with a filler material having a refractive index, and the refractive indices of the filler material and the light guide material can be mismatched by about 0.3 or less.

Another innovative aspect of the subject matter described in this disclosure can be implemented in an optical system. The optical system includes a light guide formed of a material with a refractive index and having a plurality of angled slots. The light guide includes a first major surface and a second major surface opposite the first major surface. The plurality of angled slots can be defined by undercuts extending from the first major surface toward the second major surface and at least partially through the light guide. The plurality of angled slots can include a first sidewall and a second sidewall. The first sidewall can be substantially parallel to the second sidewall. The plurality of angled slots can be filled with a filler material having a refractive index, and the refractive indices of the filler material and the light guide material can be mismatched by about 0.3 or less.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A-9B show examples of cross sections of optical systems having angled slots.

FIGS. 10A-10B show examples of cross sections of angled slots.

FIG. 11 shows an example of a plot of Fresnel reflection versus refractive index mismatch for an angled slot.

FIG. 12 shows an example of a cross section of an optical system having a light source.

FIG. 13 shows an example of a cross section of an optical system having a light receiving device.

FIGS. 14A-14B show examples of cross sections of optical systems having displays.

FIGS. 15A-15B show examples of cross sectional views of optical systems with angled slots oriented in different directions.

FIG. 16 shows an example of a cross section of an optical system having cladding layers along major surfaces of the light guide.

FIGS. 17A-17B are examples of top plan views of various optical systems.

FIG. 18 shows an example of a flow diagram illustrating a method of manufacturing an optical system.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Some implementations disclosed herein include an optical system with a light guide having light turning features formed by angled slots filled with an index-mismatched material. In some implementations, the light guide is substantially planar and the angled slots may be filled with a non-gaseous, transparent, index-mismatched material. The angled slots may be defined by undercuts extending from a first major surface toward a second major surface of the light guide. In some implementations, the angled slots extend partially through the light guide and in some implementations, the slots extend at least partially through the light guide. The slots can have substantially parallel sidewalls. The plurality of angled slots may be filled with a filler material having a refractive index that is mismatched by about 0.3 or less relative to the refractive index of the light guide material. In some implementations, the refractive index mismatch is about 0.3 or less, about 0.1 or less, or about 0.05 or less. A small index mismatch at the interfaces or sidewalls of the filled angled slots causes a small portion of light traveling within the light guide to be redirected out of the light guide at each interface, while the majority of the incident light stays within the light guide and may continue to propagate within the light guide by total internal reflection (TIR). The light that is redirected out of the light guide may be considered to be extracted out of the light guide and thereby emitted by the light guide.

In some implementations, a cladding layer may be provided along the top and/or bottom major surface of the light guide. The cladding layer may be formed of the same material as the filler material. The cladding layer may include, for example, a transparent adhesive material such as a UV-curable epoxy that also serves to laminate the light guide to another substrate such as a display, a cover glass, a transparent overlay, or a touch panel. The cladding layer may serve to enhance total internal reflection of light traveling within the light guide, such as when the index of refraction of the cladding layer is less than the index of refraction of the base light guide material.

Particular implementations of the subject matter described in this disclosure can be implemented to realize one or more of the following potential advantages. For example, some implementations disclosed herein utilize light turning features including angled slots that are filled with a slightly refractive index-mismatched material to reflect a small portion of the light incident on the slots, while passing the majority of the incident light to the next angled slot. Because the percentage of incident light that is reflected at the boundary of each angled slot is small, a large number of angled slots can be placed throughout the light guide to provide fine control over the distribution of light emitted from the light guide so as to provide uniform or other desired profiles for the emission of light from a major surface of the light guide. For example, the geometry, position, depth, pitch and profile of the angled slots can be varied to achieve the desired light emission profile.

In some implementations, substantially uniform light emission can be attained across light guides having large areas. In some implementations, by providing angled slots with substantially planar boundaries, the aggregate light-extraction efficiency of the slots may be high, while the scattering of light in undesired directions can be kept at a low level. In addition, a high level of transmission of light through the light guide can be retained. The high light transmission can facilitate uniform or other light emission profiles by allowing a larger fraction of light to propagate through the light guide than if the reflectivity of the slots were higher and the light transmission were lower. In implementations where the light guide is used in a front light to illuminate a reflective display, the high light transmission of the slots provides a low level of light scattering or other optical artifacts for light reflected from the display towards a viewer.

In front light implementations, for example, one or more light sources such as LEDs can inject light into one or more sides or corners of the light guide, and as the light from the light sources travels across the light guide, a small portion of the light passing through each angled interface is reflected towards a reflective display. Light reflected from the display then passes back through the light guide for external viewing with low distortion and transmission loss from the angled slots. As a result of one or more of the advantages noted herein, high quality images may be displayed.

In backlight implementations for an LCD or other transmissive display, for example, one or more light sources can inject light into one or more sides of a light guide with filled angled slots. As the injected light passes through each filled slot, a small portion is reflected out of a major surface of the light guide and through the display, while the remaining portions of the light continues towards the next slot. In a residential or commercial lighting implementation, for example, light injected into one or more sides of a light guide or panel is redirected out of a major surface of the light panel. The slot depth, pitch, profile, and position can be adjusted throughout the light panel to achieve a substantially uniform emission profile over the entire panel, or other profile as desired. In a reverse mode of operation, a light guide with filled angled slots can be configured to redirect some of the light incident on a major surface of the light guide towards one or more sides or corners of the light guide, where a sensor such as a photodetector or an imaging device may be positioned. In a solar window implementation, one or more photovoltaic devices or solar cells may be positioned along one or more edges or corners of the light guide, allowing some light passing through the window to be converted to electricity while the rest of the light passes through for viewing and lighting purposes. In other implementations, the slots may be curved to provide a lensing or focusing action whereby light impinging on a major surface of the light guide is redirected and focused onto one or more points along an edge or corner of the light guide. Conversely, the slots may be curved to allow light from one or more LEDs or light sources positioned along an edge or corner of the light guide to be redirected, extracted, and emitted from a major surface of the planar light guide.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

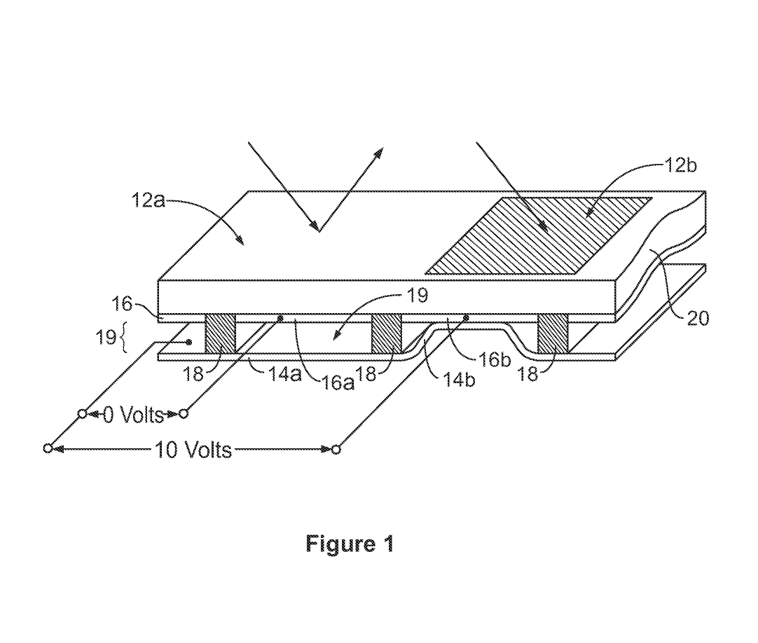

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

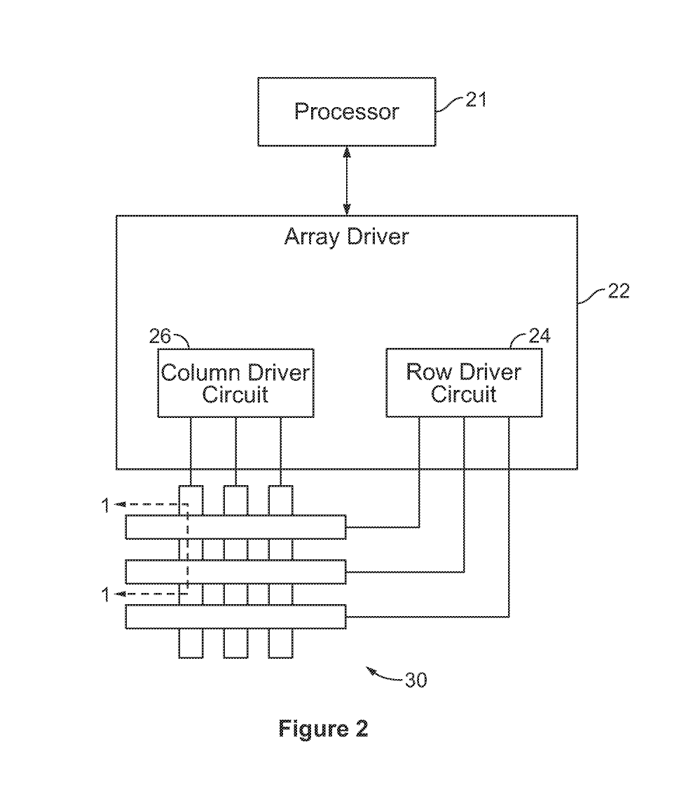

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

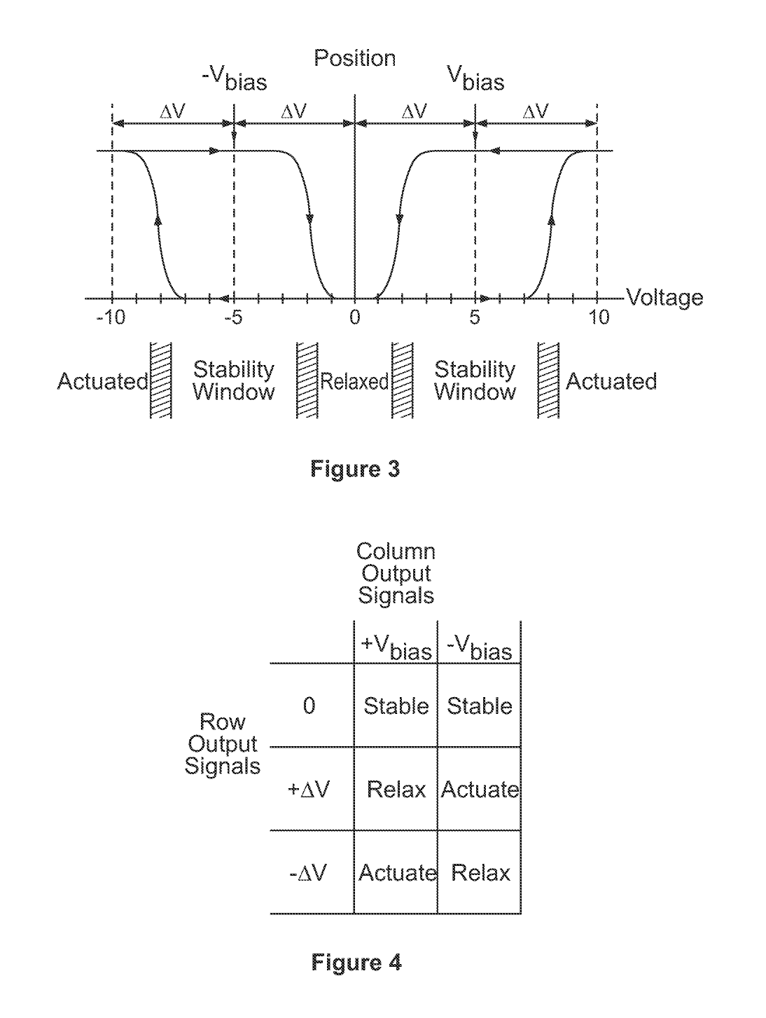

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5 volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

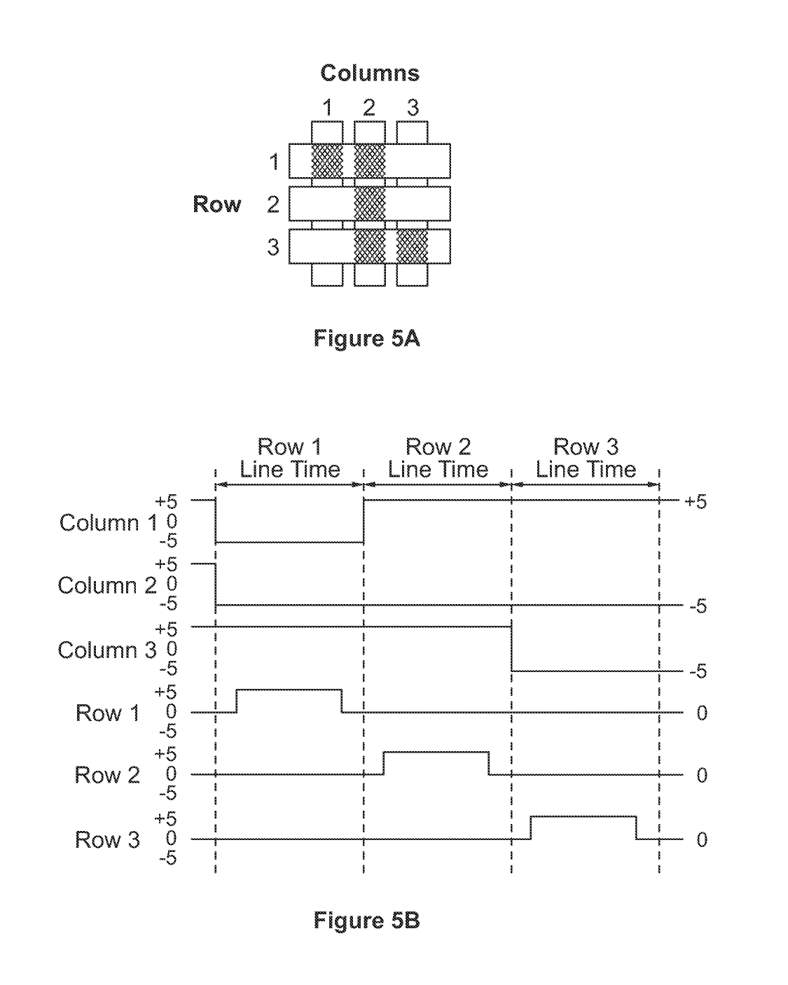

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

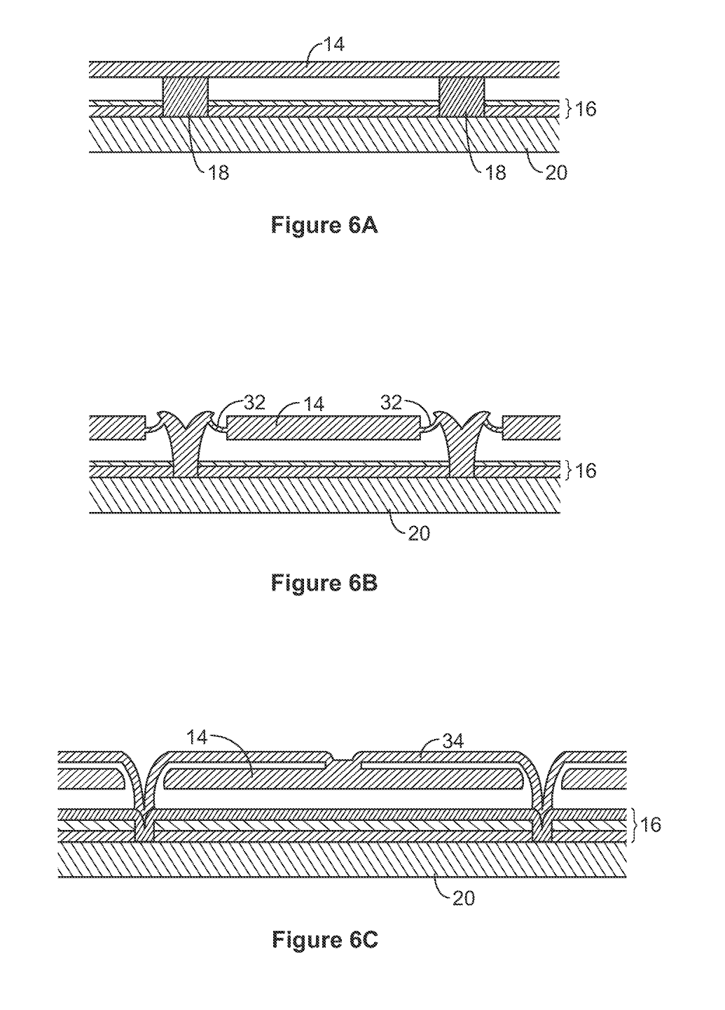

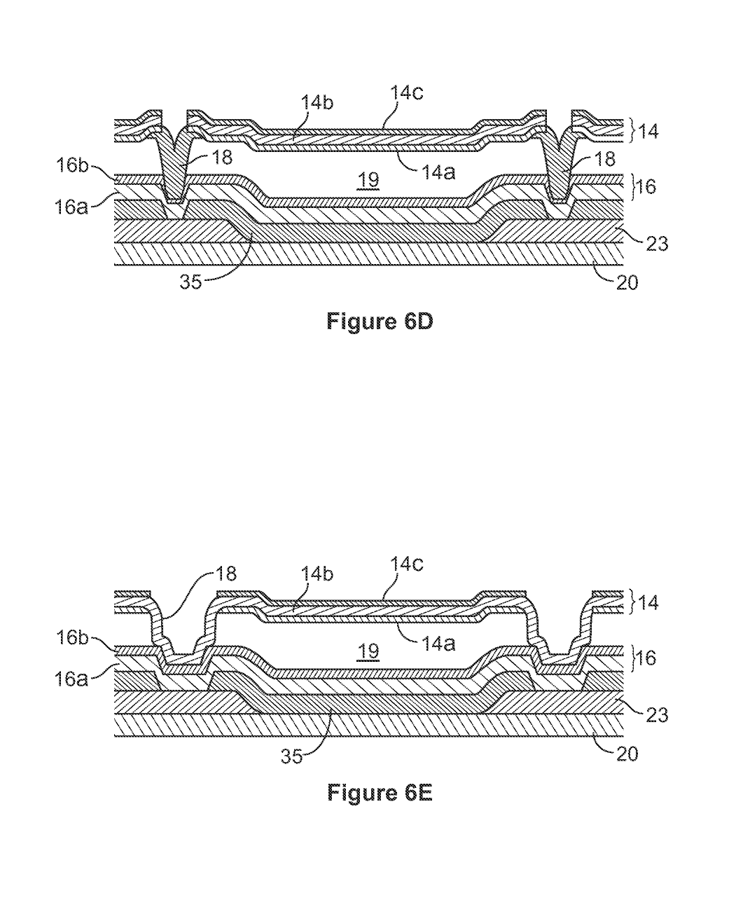

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a spacer layer (which may be formed of, for example, SiO₂), and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

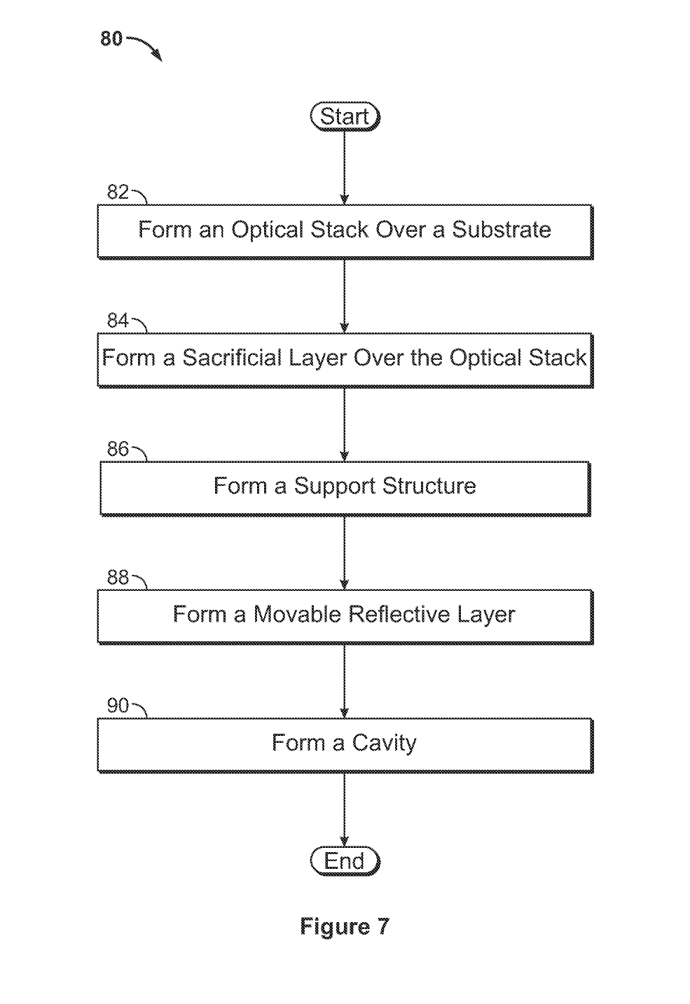

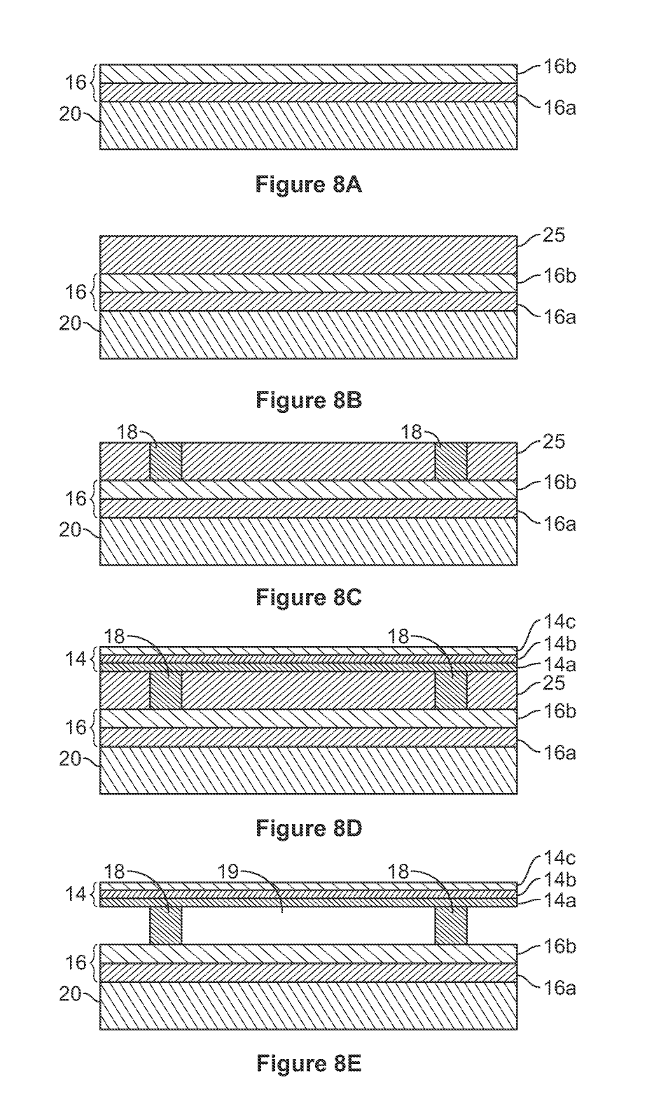

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Because reflective displays such as IMOD displays use ambient light to generate images, such displays can benefit from illumination devices that augment or replace incident ambient light in environments were the level of ambient light is lower than desired. Such illumination devices may be called front lights since they are present at the “front” side of a display, which is the side of the display that faces a viewer. In some front lights, as described herein, Fresnel reflections in a light guide may be utilized to illuminate a display. In addition, light guides with Fresnel reflection-based light turning features can also be used in other applications, including, without limitation, general ambient illumination, as further described herein.

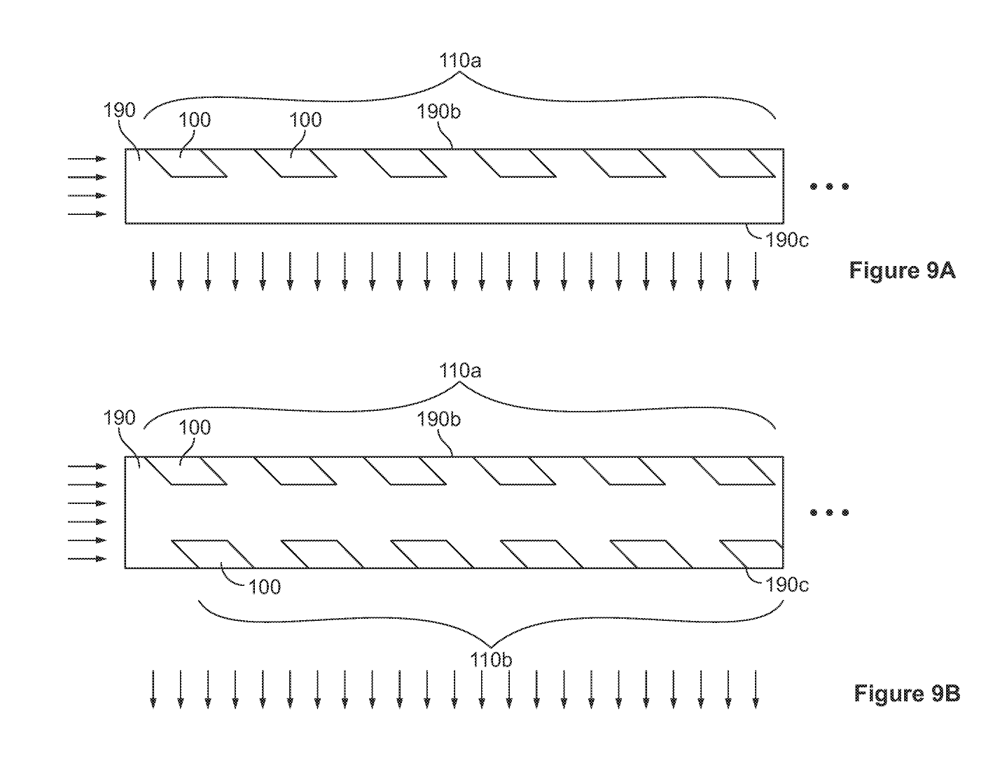

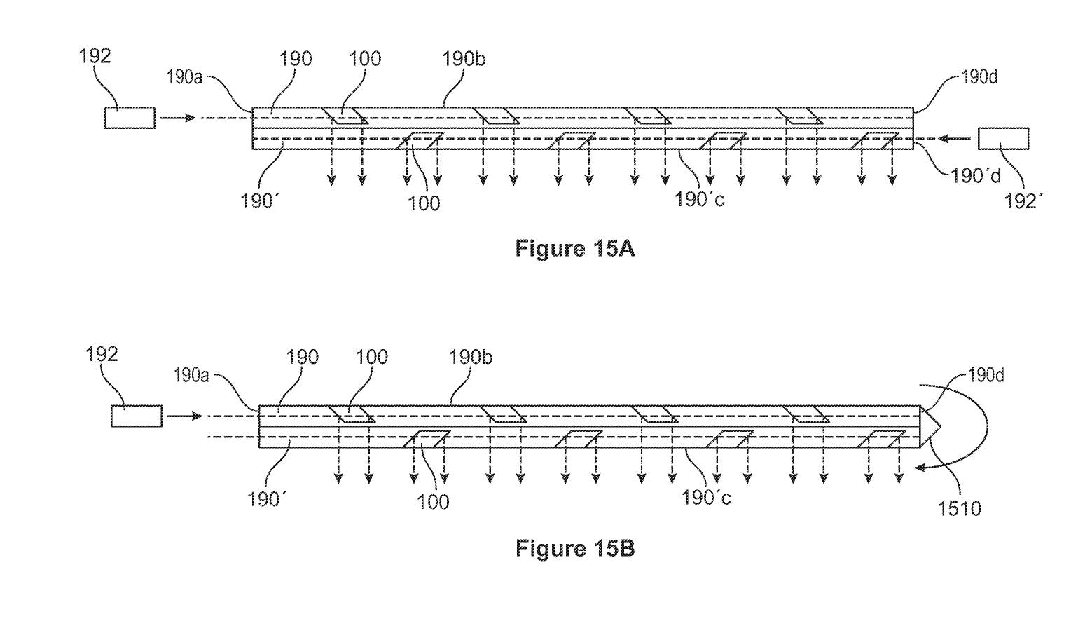

FIGS. 9A-9B show examples of cross sections of optical systems having angled slots. The optical systems each include a light guide 190 formed of an optically transmissive material and including a plurality of light turning features formed by a first plurality 110a of angled slots 100. The angled slots 100 may be defined by undercuts extending from a first major surface 190b toward a second major surface 190c and partially through the light guide 190. The second major surface 190c is opposite the first major surface 190b and may be substantially parallel to the first major surface 190b. The plurality of angled slots 100 are filled with a non-gaseous optically transmissive filler material having a refractive index that differs from the refractive index of the material forming the light guide 190. The refractive indices of the filler material and the light guide material may be mismatched by about 0.3 or less. In some implementations, the refractive indices of the filler material and the light guide material can be mismatched by about 0.2 or less, 0.1 or less, or about 0.05 or less. As the index mismatch between the light guide material and the filler material is reduced, the amount of incident light reflected at the interface between the two materials diminishes, allowing control over the amount of light reflected or otherwise turned at each interface. In some implementation, as illustrated, light represented by arrows, with the direction of the arrows indicating the direction of the light, may be injected into an edge of the light guide 190 and ejected out of the light guide 190 through the second major surface 190c. As illustrated, in some implementations, the angled slots 100 formed on the first major surface 190b are configured and oriented relative to a light source, such as an LED, so as to eject light out of the second major surface 190c opposite the first major surface 190b. However, in other implementations, the angled slots 100 formed on a major surface can be oriented relative to a light source so as to eject light out of the same major surface on which the angled slots 100 are formed. The “light source” can also include recycled light reflected back into the light guide 190 (for example, as shown in FIG. 15B).

With reference to FIG. 9B, in some implementations the optical system can further include a second plurality 110b of angled slots 100 defined by undercuts extending from the second major surface 190c partially through the light guide 190. In some implementations, the second plurality 110b of angled slots 100 is different than the plurality of angled slots 100 extending from the first major surface 190b. For example, in some implementations, the second plurality 110b of angled slots 100 can be filled with a filler material different that the filler material of the first plurality 110a of angled slots 100, and the refractive index difference between the filler material and the light guide material may be different. In some implementations, the angles defined between surfaces of the angled slots 100 and the major surface in which they are formed may be different between angled slots 100 formed on the first major surface 190b and those on the second major surface 190c. In some implementations, the angles slots 100 in the first major surface 190b may point in an opposite direction from those on the second major surface 190c. As illustrated, in some implementations, the angled slots 100 of the first plurality 110a of angled slots formed on the first major surface 190b are oriented relative to a light source so as to eject light out of the second major surface 190c opposite the first major surface 190b, while the angled slots 100 of the second plurality 110b of angled slots formed on the second major surface 190c are oriented relative to a light source so as to eject light out of the same major surface, that is, the second major surface 190c. In some implementations, the distribution of the second plurality 110b of angled slots 100 on the surface 190c can vary from that of the first plurality 110a of angled slots 100 on the surface 190b. For example, slots of the second plurality 110b of slots 100 may be vertically aligned with the gaps between slots of the first plurality 110a of slots 100, which can facilitate highly uniform light emission by providing a uniform distribution of slots 100 across the light guide 190. For example, the angled sidewalls of the slots 100 on each side of the light guide 190 may be configured such that angled sidewalls provide a substantially continuous reflecting surface across the second major surface 190c, so that light injected into a side of the light guide 190 is turned and reflected out of a portion or all of the second major surface 190c.

The light guide 190 can be formed of one or more layers of optically transmissive material. Examples of materials can include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof. In some implementations, the optically transmissive material is a glass. The thickness of the light guide 190 can be varied depending upon the application in which the light guide 190 is used. In some implementations, the light guide 190 can be about 300 to about 700 microns thick. In some implementations, the light guide 190 may have a thickness between about 50 microns and about 500 microns. In some implementations, the thickness of the light guide 190 may be between about 10 microns and about 100 microns.

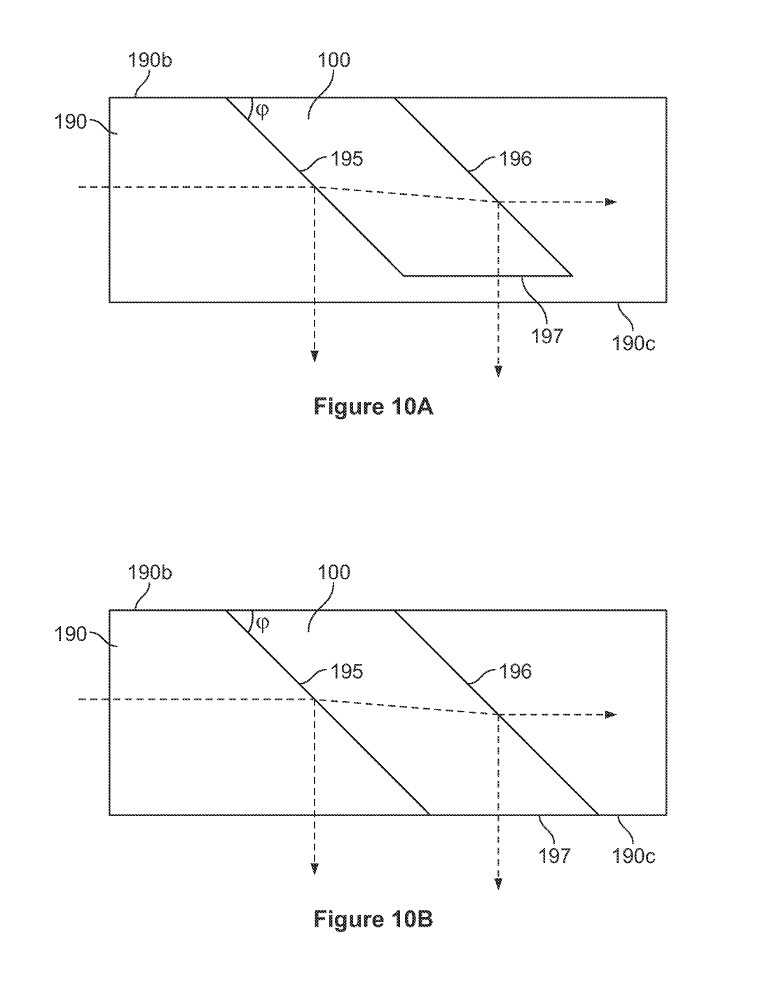

FIGS. 10A-10B show examples of a cross section of an angled slot. With reference to both FIGS. 10A and 10B, in some implementations, the angled slot 100 can include a first sidewall 195 and a second sidewall 196. In some implementations, the first sidewall 195 can be substantially parallel to the second sidewall 196. A bottom surface 197 of the angled slot 100 can be substantially parallel to the first major surface 190b and/or the second major surface 190c. The angled slot 100 can be defined by an angle φ between the first sidewall 195 and the first major surface 190b of the light guide 190. In some implementations, the angle φ is less than 90 degrees. In some implementations, the angle φ is about 45 degrees. Angles of greater or less than 45 degrees are also contemplated and allow for the direction of emitted or ejected light to be varied as desired. While illustrated with straight sidewalls and bottom surfaces for ease of discussion and illustration, the direction of emitted light may also be varied by providing contours (for example, differently angled surfaces, or curved sidewalls as viewed from the side or from above) and/or non-uniform topology in one or more of these sidewalls or surfaces. In some implementations, the bottom surface 197 may be formed perpendicular to sidewall 195 or 196.

With reference to FIG. 10A, in some implementations, the angled slot 100 extends partially through the light guide 190. With reference to FIG. 10B, in some implementations, angled slot 100 extends completely through the light guide 190, which can provide a larger reflection surface and higher levels of light extraction, relative to angled slots that extend only partially through the light guide 190. The first sidewall 195 and the second sidewall 196 can be contiguous with the second major surface 190c.

With reference to both FIGS. 10A and 10B, the angled slot 100 is filled with a filler material. In some implementations, the filler material can include a transparent adhesive configured to attach other structures, such as a protective cover or display. In some implementations, the filler material is an epoxy, which may provide substantially void-free assemblies and also facilitating the attachment of other structures (for example, other layers, displays, etc.). In some implementations, the filler material is a UV-curable epoxy or compound. In some implementations, the filler material may include a non-gaseous transparent filler material including, without limitation, an acrylic, a polycarbonate, a transparent polymer, a transparent epoxy, a transparent adhesive, a silicone, or combinations thereof. Due to the sensitivity of light extraction to the refractive index of the filler material, in some implementations, the refractive index of the material is able to withstand exposure to environment conditions (for example, UV, temperature, and humidity) and is substantially stable over the expected life of devices provided with the angled slots 100. Angled slots 100 that extend partially through the light guide 190 may allow of high levels of mechanical stability and ease of filling the slots. Because the partially through slots already have a bottom, a bottom need not be provided to stop the leakage of filler material during fabrication.

In some implementations, a portion of the filler material can contain diffusive particles, which can diffuse extracted light. Alternatively, or in addition, a diffusive layer may be provided above or below the light guide 190. In some other implementations, to reduced undesired specular reflections, an antireflective coating may be applied to one or more of the surfaces 190b, 190c, and 197, or the sidewalls 195 or 196.

With continued reference to both FIGS. 10A and 10B, the width of the angled slots 100 can be varied throughout or within the light guide 190 to increase or decrease the number of interfaces per area in the light guide 190, thereby increasing or decreasing, respectively, the amount of light extracted per area of the light guide 190. In some implementations, the width of the angled slots 100 can be about 5-50 microns, about 25-250 microns, or about 100-1000 microns. The width is the maximum distance between opposing sides 195 and 196 of the angled slots 100, which distance is measured along an axis substantially parallel to the surface in which the angled slots are formed. In some implementations, the widths of the angled slots 100 are less than the average distance between the angled slots 100 along the axis. For example, the average distance may be about 1 or more, about 2 or more, about 5 or more, or about 10 or more times greater than the widths of the angled slots 100. It will be appreciated that the angled slots 100 refract light that continues to propagate through those slots, such that the light is displaced, or exits a slot, at a different level than when it entered the slot. This is illustrated in both FIGS. 10A and 10B. The displacement may be reduced by angled slots of relatively narrow width, since the amount of displacement is proportional to the width of the slots.

In some implementations, the angled slots 100 may extend partially or completely through light guide 190, with a separation between adjacent slots on the order of the thickness of the light guide 190; the depth of angled slots 100 as measured perpendicular to a major surface of the light guide 190 may be a small fraction of the light guide thickness, may extend all the way through the light guide 190, or may be somewhere between. For example, the angled slots 190 may have a width of about 25 microns and extend halfway through a 500-micron thick light guide, with a pitch of about 250 microns. The slot depth may be uniform or varied throughout the light guide 190 to allow control over the spatial intensity of emitted light. Other geometrical features of the angled slots 100, such as their length, the spacing between adjacent slots, and their pattern throughout the light guide 190, can also allow control over the spatial intensity of emitted light.

It will also be appreciated that the refraction of light at the first sidewall 195 can cause the light to impinge on the second sidewall 196 at a different angle than the first sidewall 195. Thus, the angle of light extracted by the second sidewall 196 may be different from that extracted by the first sidewall 195. In some implementations, this difference may be utilized to provide some variation in the direction of emitted light (for example, to increase light emission and viewing angles in a particular direction) or the variation may be reduced by angling the second sidewall 196 to compensate for the refraction of light at the first sidewall 195.

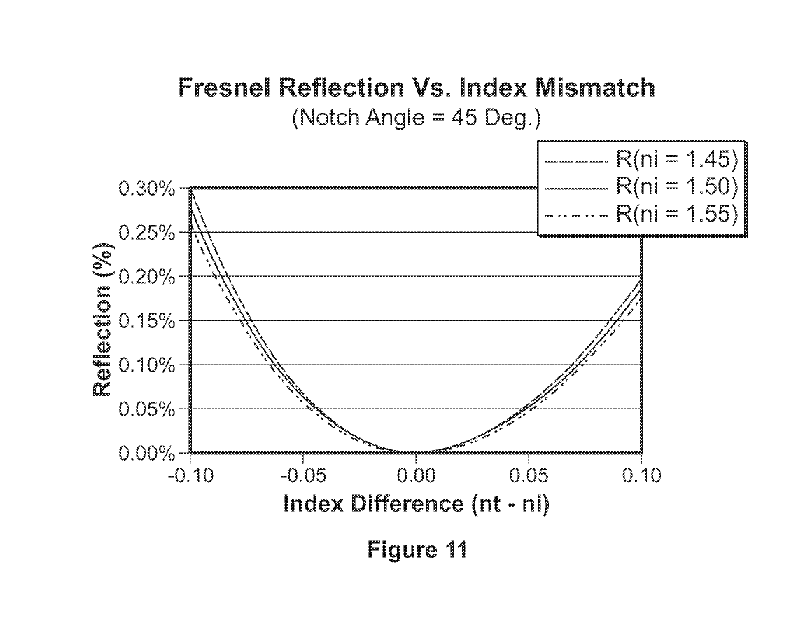

FIG. 11 shows an example plot of Fresnel reflection versus refractive index mismatch for an angled slot. In some implementations, the angled slot 100 can be configured to redirect light so that the light is ejected out of one of the first major surface 190b and/or the second major surface 190c principally by Fresnel reflections. In some implementations, the filler material directly contacts the sidewalls 195 and 196 of the angled slots 100 and reflections off those sidewalls occur without there being a reflective (for example, metallic) coating formed of another material on those sidewalls. Fresnel reflections can occur when light passes through an interface between two dielectric materials having differing indices of refraction, such as glass and air or two types of plastic.

It will be appreciated that for materials with no appreciable index mismatch, no Fresnel reflection takes place. Materials with a small mismatch result in a small amount of Fresnel reflection, allowing many angled slots 100 to be positioned in a light guide 190 with each angled slot 100 reflecting a small portion of the light while transmitting the remaining light to the next angled slot 100. For example, as shown in FIG. 11, the fractional Fresnel reflection, in percent, is plotted versus the difference in the index of refraction between the light guide material and the filler material, for a 45-degree angled slot 100. Curves are shown for three different indices of refraction for the light guide material (n=1.45, 1.5, and 1.55). Materials with an index of refraction that is higher or lower than the light guide material cause Fresnel reflection of light traveling through the light guide 190. It will be appreciated that an index mismatch of about 0.05 results in a fractional reflectance of about 0.05% per sidewall 195 and 196. Twice this mismatch in refractive indices results in a three- to six-fold increase in Fresnel reflectance. For example, as shown in FIG. 11, a refractive index mismatch of about 0.1 results in a fractional reflectance of about 0.17% per sidewall 195 and 196.

Referring again to FIGS. 10A-B, the index mismatch at each sidewall 195 and 196 causes a small portion of light traveling within the light guide 190 to be redirected out of the second major surface 190c, while light not subject to Fresnel reflection stays within the light guide 190 and propagates through the angled slot 100. The fractional Fresnel reflection can be varied over a wide range, for example, from zero to a few percent or more depending on the angle φ of the sidewalls 195 and 196 and the degree of refractive indices mismatch. In some implementations, the filled angled slot 100 can be configured to eject about 0.01% to about 3% of the light incident at each of the sidewalls 195 and 196. In some implementations, about 97% or more, 99% or more, 99.5% or more, 99.8% or more, 99.9% or more, 99.95% or more, or 99.98% or more of the light incident one of the surfaces 195 and 196 of the angled slots 100 (FIG. 10A and 10B) is transmitted and propagates through those surfaces rather than being reflected.

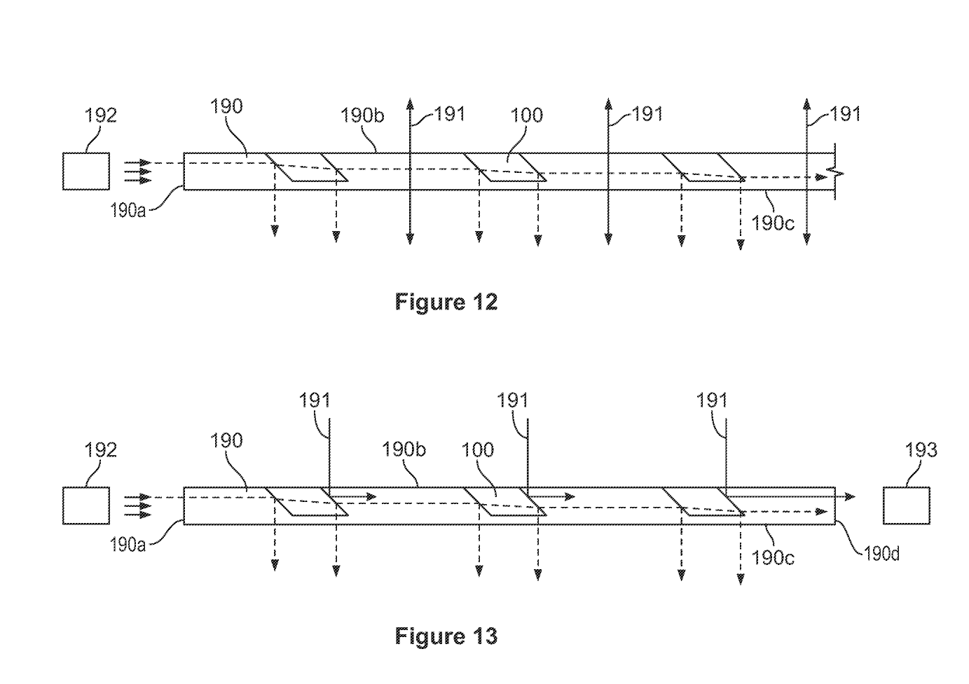

FIG. 12 shows an example of a cross section of an optical system having a light source. In some implementations, the light guide 190 includes a first light-input edge 190a for receiving light from the light source 192. In some implementations, one or more light sources 192 can be located on at least one edge, corner or center of a side of the light guide 190. The light source 192 may include a light emitting diode (LED), although other light emitting devices are also possible. For example, the light source 192 can be any light emitting device, such as, but not limited to, an incandescent light bulb, a laser, or a fluorescent tube. In some implementations, the light source 192 may be a plurality of light emitting devices arrayed along a light input edge 190a. In certain implementations, the light source 192 can be a light bar extending along the majority of the length of the light input edge 190a.

With continued reference to FIG. 12, light emitted from the light source 192 propagates into the light guide 190. The light is guided therein, for example, via total internal reflection at surfaces thereof, which can form interfaces with air or some other surrounding fluid or solid medium. In some implementations, optical cladding layers (not shown) having a lower refractive index than the refractive index of the light guide 190 (for example, approximately 0.05 or more lower than the refractive index of the light guide 190, or approximately 0.1 or more lower than the refractive index of the light guide 190) may be disposed on the upper and/or lower major surfaces 190b and 190c of the light guide 190 to facilitate TIR off of those surfaces.

In some implementations, ambient light 191 can travel through the thickness of the light guide 190 in either direction between the first major surface 190b and the second major surface 190c with little distortion or loss in intensity. Thus, it will be appreciated that in a light guide with angled slots 100, the light entering the light guide from a light source 192 can be emitted predominantly out of only one surface 190c, with minimal distortion or loss in intensity of light traversing the light guide from one major surface to another. In some implementations, the light guide 190 can be configured to be substantially transparent when viewed through the first major surface 190b and the second major surface 190c. Thus, light rays 191 may freely propagate through the light guide 190.

In some implementations, some portions of the light guide 190 may not be substantially transparent when viewed through the first major surface 190b and second major surface 190c. For example, portions of the first major surface 190b or second major surface 190c of the light guide 190 can be colored, whitened, blackened, opaque, silvered, reflective or mirrored, due for example to the presence of other structures such as a deposited metal film or a colored paint on a major surface of the light guide 190. A lighting panel, for example, may include one or more light sources 192, a planar light guide 190 with a plurality of angled slots 100 filled with an index-mismatched transparent material, and where one of major surfaces 190b or 190c is a mirrored or colored (for example, white) major surface, so that light injected into an edge of the light guide 190 would be ejected by the angled slots 100 out of an other of the major surfaces 190c or 190b. In some implementations, the angled sidewalls of the angled slots 100 can be configured to redirect light traveling within the light guide 190 out of an uncoated major surface, with the other major surface coated or uncoated with structures such as a deposited metal film or a colored paint. Alternatively, the angled slots can be configured to redirect light traveling within the light guide 190 onto a reflective or dispersive coating on one major surface, the redirected light then traversing back into and through the thickness of the light guide 190 and out the other major surface.

FIG. 13 shows an example of a cross section of an optical system having a light receiving device. In some implementations, the light receiving device can include one or more optical sensors and/or photovoltaic cells, which can be positioned on a portion or more of an edge or corner of the light guide 190 to receive the light. For example, the optical system can further include a photovoltaic cell 193 disposed at an edge 190d of the light guide 190. Where the light source 192 is present, the photovoltaic cell may be used to convert ambient light into electrical energy and/or to recycle energy from the light source 192 by converting non-extracted light from the light source 192 into electrical energy. In some implementations, the angled slots 100 are configured to eject incident ambient light out of the edge 190d of the light guide 190 toward the photovoltaic cell 193 principally by Fresnel reflections. In some implementations, the light guide 190 forms a transmissive structure, such as a window, which allows light to be transmitted through it with low levels of distortion, while also redirecting some of this light to photovoltaic cells 193. Such a light guide 190 may or may not be provided with a light source 192. Where the light source 192 is present, the light guide 190 may function as an ambient light, to illuminate the space in which the window is situated, for example, when it is dark outside.

In some implementations, the optical system can include a light sensor disposed at an edge of the light guide 190. In some implementations, a portion of the light entering the first major surface 190b (or second major surface 190c) is redirected by the angled slots 100 toward the light sensor. In some implementations, the light source 192 may be omitted. The angled slots 100 may be curved to redirect and focus ambient light onto one or more photovoltaic cells or light sensors along one or more sides or corners of the light guide.

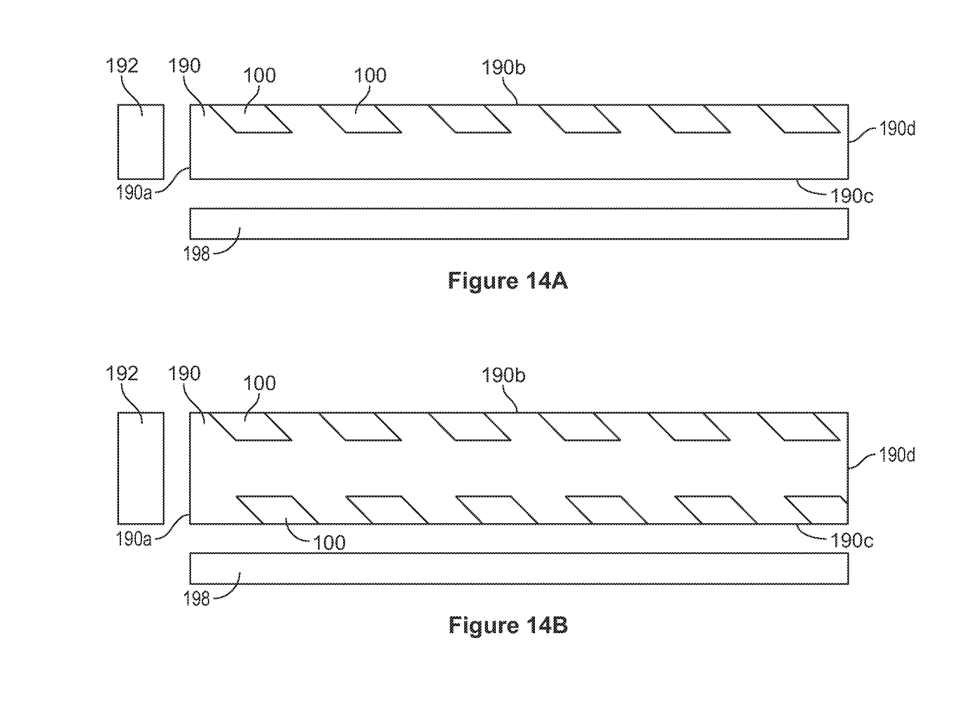

FIGS. 14A-14B show examples of cross sections of optical systems having display devices. With reference to both FIGS. 14A and 14B, the light guide 190 may be disposed adjacent to a target 198, such that a major surface of the light guide 190 (for example, the second major surface 190c) faces the target 198. In some implementations, the target may be a display. The angled slots 100 may be configured to eject light from the light source 192 towards the display 198. The display 198 can include various display elements, for example, a plurality of spatial light modulators, interferometric modulators, liquid crystal elements, electrophoretic elements, etc., which can be arranged parallel the major surface of the panel 198. The display 198 can include interferometric modulators such as the interferometric modulators 12 of FIG. 1 in some implementations. In some implementations, where the display elements are reflective, the system including the light guide 190 acts as a front light. Light is extracted out of the light guide 190 and directed towards the display 198, then reflected from the display 198 and transmitted back through and out of the light guide 190 towards a viewer. In some other implementations, where the display elements are transmissive, the system including the light guide 190 acts as a back light. Light is extracted out of the light guide 190 and is transmitted through the display 198 towards a viewer. While shown as uniformly spaced for ease of illustration, in some implementations, the positions of the angled slots 100 may be “randomized” or slightly varied from a uniform spacing, which can reduce optical artifacts such as Moiré patterns when the angled slots 100 overlap with display elements. Angled slots 100 are shown on a single surface of light guide 190 in FIG. 14A, and on both major surfaces of light guide 190 in FIG. 14B. A coupling layer such as a transparent adhesive (not shown) may be positioned between the light guide 190 and the display 198. The coupling layer may include or serve as a diffuser in some implementations.

FIGS. 15A-15B show examples of cross sectional views of optical systems with angled slots oriented in different directions. In some implementations, one or more light guides may be disposed adjacent to or stacked on each other. With reference to both FIGS. 15A and 15B, in some implementations, a first light guide 190 is stacked on a second light guide 190′. In some implementations, a lower refractive index cladding layer (not shown, but described briefly in discussion of FIG. 12) may be disposed between the first and second light guides 190 and 190′ to prevent undesired light leakage between the two light guides. In some implementations, the angled slots 100 of the first light guide 190 are oriented in a direction opposite the angled slots 100 formed in the second light guide 190′. For example, the sidewalls of the angled slots 100 of the light guide 190 and the sidewalls of the angled slots 100 of the second light guide 190′ may point away from the first major surface 190b in generally opposite directions. In some implementations, the angled slots 100 formed in the first light guide 190 and the second light guide 190′ are configured to redirect incident light from the light source 192 incident so that the light propagates out of the light guides 190 and 190′ (for example, outside of the second major surface 190′c). In some implementations, the first and second light guides 190 and 190′ are substantially the same. In some implementations, the first and second light guides 190 and 190′ may be different. For example, the first and second light guides 190 and 190′ may be formed of different materials (such as materials with different refractive indices) and/or may have different distributions and/or sizes of angled slots 100.

With reference to FIG. 15A, in some implementations, the optical system may include two more or light sources. In some implementations, the light source 192 is disposed adjacent the light input edge 190a of the first light guide 190 and a second light source 192′ is disposed adjacent the light input edge 190′d of the second light guide 190′. In some implementations, light emitted from the light source 192 propagates into the first light guide 190 through the light input edge 190a. In some implementations, light emitted from the second light source 192′ propagates into the second light guide 190′ through the light input edge 190′d. In some implementations, the light emitted from the light sources 192 and 192′ is guided, for example, via total internal reflection at the surfaces of the light guides 190 and 190′, respectively, which may form interfaces with air or some other surrounding fluid or solid medium having a lower refractive index. Increased light output may be obtained from the composite light guides 190 and 190′. Three or more light guides 190 may be stacked in a similar manner with light sources on three or more sides (not shown). Alternatively or in addition to, filled angled slots 100 may be configured in a crisscrossed or cross-hatched manner to accommodate light sources on multiple sides.

In some implementations, light that is not extracted out of the light guide 190 can be recycled, thereby increasing the efficiency of the optical system. With reference to FIG. 15B, in some implementations, the optical system may include an integral surface or attached recycling structure 1510 on an edge 190d for recycling light that strikes an edge 190d opposite the light source 192. For example, in some implementations, the edge 190d may include a recycling structure 1510 configured to redirect light escaping the light guide 190, so that it is redirected to propagate within the light guide 190′. In some implementations, the recycling structure 1510 is provided with planar and/or curved surfaces that reflect light escaping from the light guide 190 into the light guide 190′. The recycling structure 1510 may include mirrored surfaces.

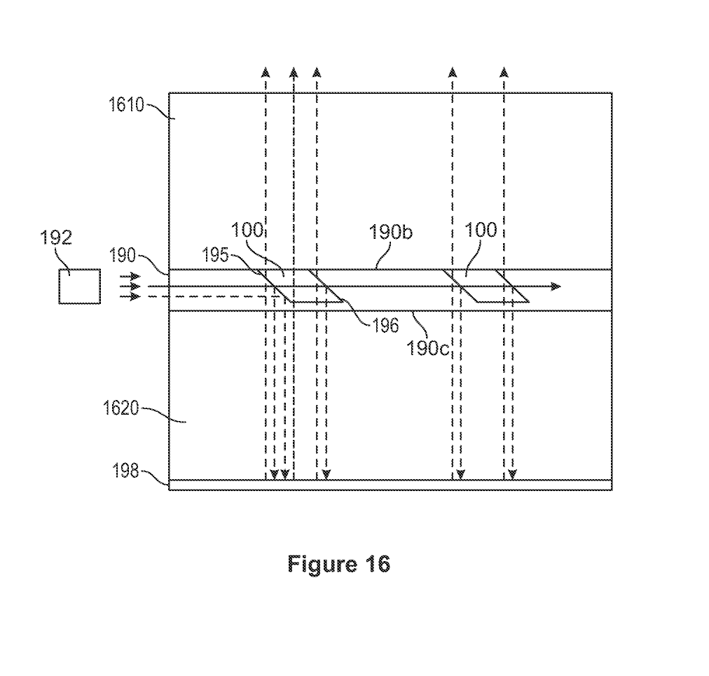

FIG. 16 shows an example of a cross section of an optical system having cladding layers along major surfaces of the light guide. In some implementations, the optical system may include the light guide 190 disposed between a first cladding layer 1610 and/or a second cladding layer 1620. Transparent substrates such as glass or plastic substrates may serve as cladding layers in some implementations. In some implementations, light reflected off of the sidewalls 195 and 196 of the angled slots 100 is reflected out of the second major surface 190c towards a target 198, which can be a display in some implementations. In some implementations, the light reflected out of the second major surface 190c, is redirected back through the major surfaces 190c and 190b of the light guide 190. In some implementations, the first and second cladding layers 1610 and 1620 are made of an optically transmissive material. The optically transmissive material can be, for example, a glass or a polymer. In some implementations, the optically transmissive material can have a refractive index similar to or the same as the refractive index of the filler material of the angled slots 100. Therefore, in some implementations, the refractive index of the filler material of the angled slots 100 is lower than the refractive index of the light guide 190 by about 0.3 or less, by about 0.1 or less, or by about 0.05 or less. As illustrated, such a refractive index match can provide a low level of reflection for light propagating vertically through the angled slots 100, thereby facilitating the efficient and low artifact propagation of light through the thickness of the light guide 190.

In some implementations, the layers 1610 and 1620 may have an index of refraction similar to that of the light guide 190 and may not function as cladding layers. In some implementations, a thin cladding layer such as a transparent adhesive (not shown) can be disposed between the layers 1610 and 1620. The thin cladding layer may be selected to have a smaller refractive index than the light guide 190 to encourage TIR for light rays traveling along the length of the light guide 190. In some implementations, the angled slots 100 extend completely through the light guide 190, which can further facilitate the propagation of light through the thickness of the light guide 190 by reducing the number of interfaces formed by different materials between a viewer and a display. It will be appreciated that some reflection may occur at each interface and in the areas where the angled slots 100 extend completely through the thickness of the light guide 100, at least one possible interface (between the slots 100 and the light guide 190) may be removed.

It will be appreciated that the angled slots 100 shown in the Figures are schematic. The sizes, shapes, densities, positions, etc. of the angled slots 100 can vary from that depicted to achieve desired light redirecting properties. For example, the angled slots 100 can be distributed in the light guide 190 in various patterns to achieve desired light turning properties. It will be appreciated that uniformity of power per area is desired in many applications to uniformly illuminate a target, such as a display. The angled slots 100 may be arranged to achieve high uniformity in power per area.

In some implementations, one or more of the plurality of angled slots 100 can extend substantially continuously across the width of the light guide 190. In some implementations, the plurality of angled slots 100 form discrete segments across the width of the light guide 190. In some implementations, a varying density of the angled slots 100 allows the extracted light per unit area to be highly uniform over the area of the light guide 190. As light propagates through the light guide 190 some amount of light contacts the angled slots 100 and is redirected out of the light guide 190. Thus, the remaining light propagating through the light guide 190 decreases with distance from the light source 192, as more and more light is redirected by contact with the angled slots 100. To compensate for the decreasing amounts of light propagating through the light guide 190, the density of the angled slots 100 can increase with distance from the light source 192.

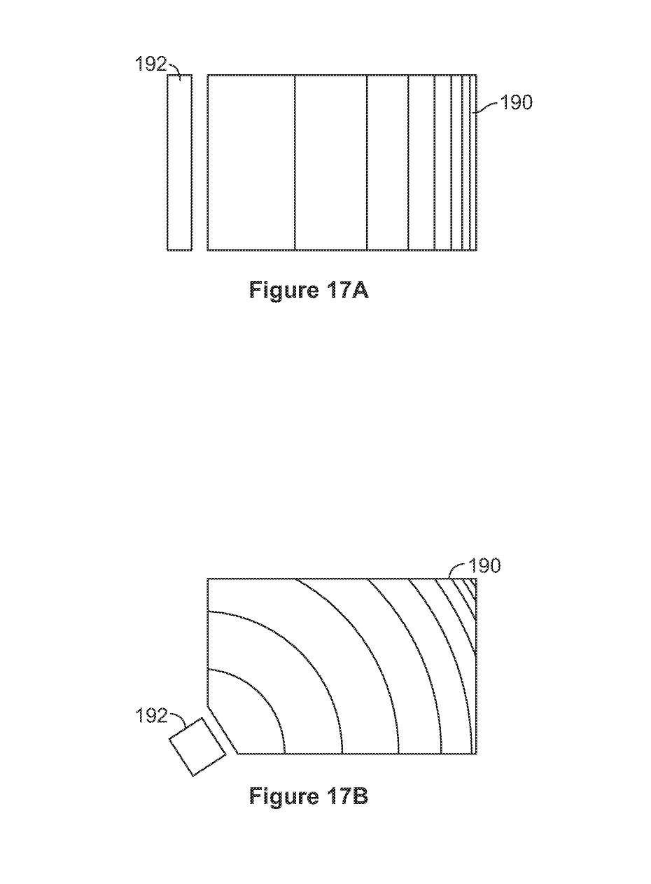

FIGS. 17A-17B are examples of top plan views of various optical systems. In some implementations, the density of the angled slots 100, in one or both of the first and second major surfaces 190b and 190c of the light guide 190 (FIGS. 17A-B), increases with increasing distance from the light source 192. The density of the schematically illustrated lines indicates the density of the angled slots 100. While the illustrated lines suggest that the angled slots 100 extend substantially continuously across the width of the light guide 190, as noted previously, in some implementations, the plurality of angled slots 100 form discrete, short segments that are a fraction of the width of the light guide 190.

With reference to FIG. 17A, the number of angled slots 100 per unit area increases with increasing distance from the edge of the light guide 190 directly adjacent the light source 192. In some implementations, the angled slots 100 (whether segments or extending substantially across a width of the light guide) may form generally straight lines parallel to the light source 192.

With reference to FIG. 17B, the angled slots 100 may also be curved (as seen from a top view) about the light source 192. The number of angled slots 100 per unit area may also increase with distance from the light source 192. For example, the light source 192 may be disposed in a corner of the light guide 190. The angled slots 100 may form semicircular segments curved about the light source 192. In some implementations, the light source 192 may be provided at a discrete point (for example, a midpoint) along the edge of the light guide 190 and the angled slots 100 may be curved about that discrete point. In some implementations, the light source 192 may be provided at an interior point in the light guide 190 and the angled slots 100 may be curved about that interior point. Provision for light sources 192 along one or more sides or corners can be accommodated, for example, with multiple layers of light guides 190 as described above with respect to FIGS. 15A-15B. Alternatively or additionally, angled slots 100 may be configured in crisscrossed or crosshatched patterns to allow additional light sources and the light from those light sources 192 to be redirected as desired. In some configurations, the angled slots 100 may be configured in segments of the light guide 190, such as half-segments or quarter-segments of the light guide 190.

It will be appreciated that the density of the angled slots 100 refers to the area occupied by the angled slots 100 per unit area of the light guide 190. A single large angled slot 100 or a plurality of smaller angled slots 100 in a given area may have the same density. Thus, the density may be changed due to, for example, changes in the sizes and/or numbers of the angled slots 100 per area. For example, in some implementations, the angled slots 100 may extend further into the body of the light guide 190 with increasing distance from the light source 192 and/or the sizes of individual segmented angled slots 100 may increase with increasing distance from the light source 192.

With reference to both FIGS. 17A and 17B, the edges of the light guide 190 may be reflective and/or absorptive. For example, mirrored layers may be provided at one or more of the edges, or locally on one or more edges, to facilitate the recirculation of light in the light guide 190, thereby increasing efficiency by increasing the probability that light injected into the light guide 190 will remain in the light guide and will impinge on an angled slot 100 at an angle that allows the light to be extracted. In some implementations, absorbers may be provided at one or more edges, or locally on one or more edges, to absorb non-extracted light, thereby reducing the probability that light scattered from the edges will escape the light guide 190 or impinge on the angled slots 100 at angles that cause undesired light emission patterns. In some implementations, some of the angled slots 100 (for example, those adjacent the edges of the light guide 190) may be filled with a light absorbing material to absorb light that has not been extracted before it reaches the edges of the light guide 190.

In some implementations, the light guide 190 described herein can be used for illumination of the ambient environment to provide, for example, residential or commercial lighting (including architectural or panel lighting). For example, the target 198 (FIGS. 14A and 14B) may be an object, such as a desk or room boundary, in the ambient environment. In some implementations, the light guide 190 can be sized as appropriate for ambient environments. For example, to efficiently couple to a larger light source and allow light to propagate over a large area, the thickness of the light guide 190 may be about 0.5 mm to about 10 mm in some lighting applications. In some lighting applications, the light guide 190 can be bent or curved in various shapes. For example, the light guide 190 may be rolled into a cylinder or placed over a non-planar surface. Planar or curved light guides 190 may be used to provide ambient illumination. The width and length of the planar light guides may have a wide range. For example, light guides may have edge dimensions of 1 cm to 1 m or larger, and formed in square, rectangular, circular or other suitable shapes. The light guides may be re-shaped into cylinders, partial cones, or other shapes as desired.

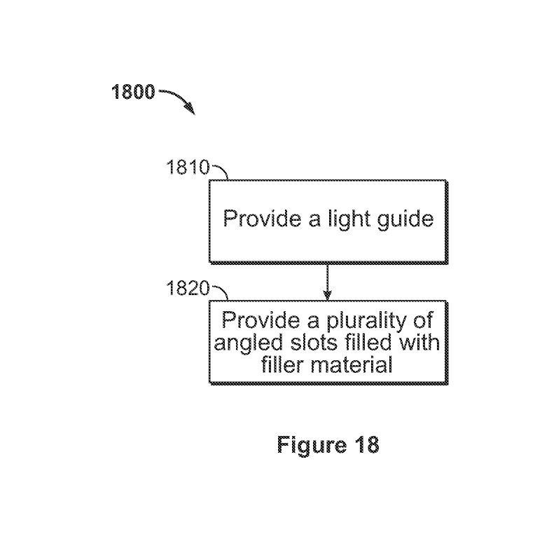

FIG. 18 shows an example of a flow diagram illustrating a method of manufacturing an optical system. The method 1800 includes a block 1810 for providing a light guide. The method 1800 also includes a block 1820 for providing a plurality of angled slots filled with filler material. The angled slots may be defined by undercuts extending from the first major surface. The filler material may have an index of refraction mismatched from the index of refraction of the material forming the light guide. In some implementations, the refractive indices of the filler material and the light guide material are mismatched by about 0.3 or less.

The angled slots can be formed by various methods. In some implementations, the angled slots are defined as the light guide is formed. For example, the light guide can be formed by extrusion through a die having an opening corresponding to a cross-sectional shape of a light guide and also having projections in the die corresponding to the angled slots. The material forming the light guide is pushed and/or drawn through the die in the direction in which the angled slots extend, thereby forming a length of material having the desired cross-sectional shape and having the angled slots. The length of material is then cut into the desired dimensions for a light guide.

In some implementations, the light guide can be formed by casting or injection molding, in which material is placed in a mold and allowed to harden. The mold contains extensions corresponding to the angled slots. Once hardened, the optically transmissive material is removed from the mold. The mold can correspond to a single light guide, such that the removed hardened material can be used as a single light guide. In other implementations, the mold produces a large sheet of material, which may be cut into desired dimensions for one or more light guides.

In some implementations, the angled slots are formed after formation of a light guide. For example, the angled slots can be formed by imprinting the shape of the angled slots in the light guide. This can be accomplished by, for example, embossing, in which a die having protrusions corresponding to the angled slots is pressed against a light propagating material to form the angled slots in the material. The material may be heated, making the material sufficiently malleable to take the shape of the angled slots. In some other implementations, the light guide is subjected to stamping, hot stamping, punching, and/or roll pressing to form the angled slots.

In some implementations, material is removed from the light guide to form the angled slots. For example, the angled slots 100 can be formed by etching, machining or cutting into the body or otherwise removing material. In some implementations, material is removed from the body by laser ablation. Other examples of suitable removal processes include machining, polishing, and assembling; sawing and polishing; hot knife cutting, and 3-D photo-machining. In some implementations, a saw blade for a circular or band saw may be used to cut the slots. The saw blade may be manufactured with a tapered edge to allow the formation of angled slots with flat bottoms.

In some implementations, a light guide may be formed in sections that are later combined. The sections can be formed using the methods disclosed herein. The sections may be adhered or otherwise attached together with a refractive index matching material to form a single light guide body. Section by section formation of a light guide body allows the formation of curved angled slots that may otherwise be difficult for a particular method to form as a single continuous structure. In some implementations, sections of the light guide are machined or sawed, and then polished and assembled together to form the whole light guide.

The angled slots may be filled with a filler material during and/or after formation. In some implementations, forming the plurality of angled slots includes filling the angled slots with an optically transmissive material and then allowing the material to harden. In some implementations, the material can be an epoxy, a UV-curable epoxy, a UV-curable compound, an acrylic, a polycarbonate, a transparent polymer, a transparent epoxy, a transparent adhesive, a silicone, or a suitable non-gaseous filler material.

In some implementations, the light guide may subsequently be attached to a light source to form an illumination system. Additional layers or structures (for example, diffusers, cladding layer, or anti-reflective coatings) may also be applied to the light guide. In some implementations, the light guide may be attached to other substrates such as a display, a cover glass, a transparent overlay, or a touch panel.

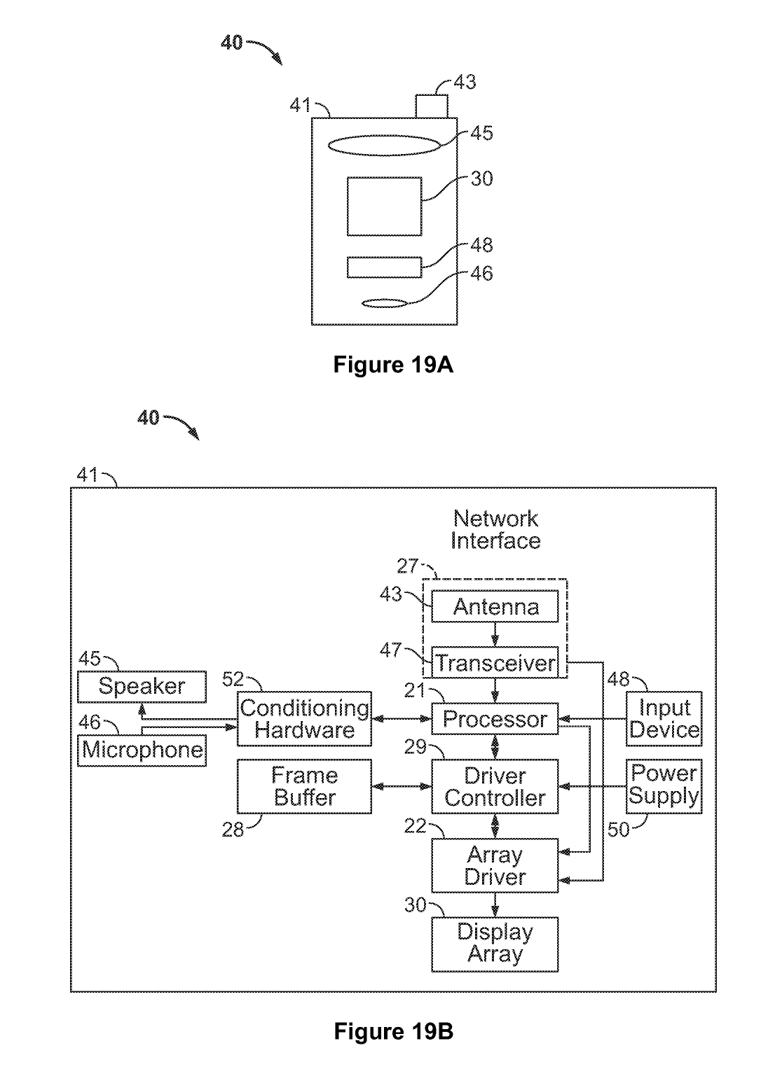

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An optical system, comprising:
a light guide formed of a material with a refractive index, the light guide including:
a first major surface;
a second major surface opposite the first major surface; and
a plurality of angled slots defined by undercuts extending from the first major surface toward the second major surface and partially through the light guide, wherein the plurality of angled slots are filled with a filler material having a refractive index, the refractive indices of the filler material and the light guide material mismatched by about 0.3 or less.

2. The optical system of claim 1, wherein the refractive indices of the filler material and the light guide material are mismatched by about 0.1 or less.

3. The optical system of claim 2, wherein the refractive indices of the filler material and the light guide material are mismatched by about 0.05 or less.

4. The optical system of claim 1, wherein the angled slots are configured to eject light out of one of the first major surface and the second major surface principally by Fresnel reflections.

5. The optical system of claim 4, wherein a sidewall of the angled slots is configured to eject out of one of the first major surface and the second major surface about 0.01% to about 3% of the light incident on the sidewall.

6. The optical system of claim 1, wherein the filler material is an epoxy.

7. The optical system of claim 1, wherein the plurality of angled slots are angled at about 45 degrees relative to the first major surface.

8. The optical system of claim 1, wherein the plurality of angled slots include a first sidewall and a second sidewall contiguous with the first major surface, wherein the first sidewall is substantially parallel to the second sidewall.

9. The optical system of claim 1, further comprising at least one light source, wherein the light guide includes a first light-input edge for receiving light from the light source.

10. The optical system of claim 9, wherein the at least one light source is located on at least one edge, corner or center of a side of the light guide.

11. The optical system of claim 1, wherein a bottom surface of the plurality of angled slots is substantially parallel to the first major surface or the second major surface.

12. The optical system of claim 1, further comprising a photovoltaic cell disposed at an edge of the light guide, wherein the angled slots are configured to eject light out of the edge of the light guide toward the photovoltaic cell principally by Fresnel reflections.

13. The optical system of claim 1, further comprising a light sensor disposed at an edge of the light guide, wherein the angled slots are configured to eject a portion of light entering one of the first major surface and the second major surface toward the light sensor.

14. The optical system of claim 1, wherein the plurality of angled slots are segmented.

15. The optical system of claim 1, wherein the plurality of angled slots are curved along the first major surface.

16. The optical system of claim 1, further comprising another plurality of angled slots defined by undercuts extending from the second major surface partially through the light guide.

17. The optical system of claim 1, wherein the filler material comprises a transparent adhesive configured to attach a cover.

18. The optical system of claim 1, further comprising:
a display including a plurality of display elements, the display elements facing one of the first major surface and the second major surface, wherein the plurality of angled slots are configured to redirect light out of the light guide and towards the display elements.

19. The optical system of claim 18, wherein the display is a reflective display.

20. The optical system of claim 18, wherein the display elements of the display include interferometric modulators.

21. The optical system of claim 18, further comprising:
a processor that is configured to communicate with the display, the processor being configured to process image data; and
a memory device that is configured to communicate with the processor.

22. The optical system of claim 21, further comprising:
a driver circuit configured to send at least one signal to the display.

23. The optical system of claim 22, further comprising:
a controller configured to send at least a portion of the image data to the driver circuit.

24. The optical system of claim 21, further comprising:
an image source module configured to send the image data to the processor.

25. The optical system of claim 24, wherein the image source module includes at least one of a receiver, transceiver, and transmitter.

26. The optical system of claim 21, further comprising:
an input device configured to receive input data and to communicate that input data to the processor.

27. An optical system, comprising:
a light guide formed of a material with a refractive index, the light guide including:
a first major surface;
a second major surface opposite the first major surface; and
means for ejecting light, propagating through the light guide by total internal reflection, out of the light guide through the first major surface principally by Fresnel reflections.

28. The optical system of claim 27, wherein the means for ejecting light includes a plurality of angled slots defined by undercuts extending from one of the first and second major surfaces partially through the light guide.

29. The optical system of claim 28, wherein the plurality of angled slots are filled with a filler material having a refractive index, the refractive indices of the filler material and the light guide material mismatched by about 0.3 or less.

30. The optical system of claim 28, further comprising at least one of a photovoltaic cell and a light sensor disposed at one or more edges of the light guide.

31. A method of manufacturing an optical system, comprising:
providing a light guide formed of a material with a refractive index, the light guide including:
a first major surface;
a second major surface opposite the first major surface; and
providing a plurality of angled slots defined by undercuts extending from the first major surface partially through the light guide, wherein the plurality of angled slots are filled with a filler material having a refractive index, the refractive indices of the filler material and the light guide material mismatched by about 0.3 or less.

32. The method of claim 31, wherein providing the light guide includes cutting at least a portion of a sheet of optically transmissive material to define the light guide.

33. The method of claim 31, wherein providing the plurality of angled slots includes removing a portion of the material forming the light guide to define the undercuts.

34. The method of claim 33, wherein providing the plurality of angled slots includes filling the angled slots with an epoxy.

35. The method of claim 31, wherein the refractive index of the filler material is lower than the refractive index of the light guide material.

36. An optical system, comprising:
a light guide formed of a material with a refractive index, the light guide including:
a first major surface;
a second major surface opposite the first major surface; and
a plurality of angled slots defined by undercuts extending from the first major surface toward the second major surface and at least partially through the light guide, wherein the plurality of angled slots include a first sidewall and a second sidewall, wherein the first sidewall is substantially parallel to the second sidewall, wherein the plurality of angled slots are filled with a filler material having a refractive index, the refractive indices of the filler material and the light guide material mismatched by about 0.3 or less.

37. The optical system of claim 36, wherein a spacing between directly neighboring angled slots varies across the light guide.

38. The optical system of claim 36, wherein a depth of the angled slots varies across the light guide.
